(19) United States
(12) Patent Application Publication
(10) Pub. No.: US 2015/0288329 A1
(43) Pub. Date: Oct. 8, 2015

(54) Junction Box

(71) Applicant: Bizlink International Corporation, New Taipei City (TW)

(72) Inventors: Jia-Mao Zheng, Shenzhen (CN); Tsung-Lin Liu, New Taipei City (TW); Shu-Quan Liu, Shenzhen (CN); Hao-Ran Zou, Shenzhen (CN); Qi-Xing Xu, Shenzhen (CN); Chun-Kao Wu, New Taipei City (TW)

(73) Assignee: Bizlink International Corporation, New Taipei City (TW)

(21) Appl. No.: 14/243,347

(22) Filed: Apr. 2, 2014

(51) Int. Cl. G01R 31/40; H01R 13/516; H01R 13/52; G01K 13/00; H01R 13/64

(52) U.S. Cl. CPC H02S 50/00; G01K 13/00; H01R 13/64; H01R 13/5219; H01R 13/516

(57) ABSTRACT

The present invention relates to a junction box comprising a housing, an electric connection module, a monitor module, and a cable module. A solar module transmits electricity generated by the solar module to a power conversion device; moreover, a plurality of signal wires of the cable module transmit the parameter supervised by the monitor module to an external monitoring and controlling device at the same time. Therefore, the monitor module can inform users the using information of the solar module such that users can judge the timing of repairing and replacing the external solar module and so as to achieve an ultimate using benefit of the solar module.

### BACKGROUND OF THE INVENTION

1. Field of the Invention

The present invention relates to renewable energy technology field, and more particularly, to a junction box having a monitor module.

2. Description of the Prior Art

There are several advantages of photovoltaic solar power that make it one of the most promising renewable energy sources in the world. The photovoltaic solar power is free, needs no fuel and produces no waste or pollution, and the solar power generator requires little maintenance and no supervision and has a life of 20-30 years with low running costs. Solar power generators are simply distributed to homes, schools, or businesses, where their assemblies require no extra development or land area and their functions are safe and quiet. Remote areas can easily produce their own supply of electricity by constructing as small or as large of a system as needed.

Generally, the solar or photovoltaic module for generating electric energy from sunlight comprises a plurality of solar or photovoltaic cells. The solar cells in a solar module are usually connected to each other by thin conductor strips (i.e. conductor ribbons). These thin conductor strips are routed out of the solar module on the side facing away from the sun. The thin conductor strips are mostly made of copper foils and protruded from the rear side of the solar module (i.e. solar panel). These flexible and thin conductor strips are very sensitive and difficult to contact. Therefore, one or more junction boxes are employed for the solar module and thin conductor strips are manually contacted with electrical terminal receptacles of the junction box. In addition, the junction box is an integral part of a solar or photovoltaic system and it provides electrical connections between the solar cells of the individual solar module (i.e. solar panel) and between the solar modules and other components of the system (i.e. DC/AC inverter). Generally, the junction box is disposed on a rear surface of the solar panel and has electrical connection mechanism in the interior for contacting the thin conductor strips of the solar modules and conducting the electrical current generated by the solar modules to the outside. Without a junction box, the solar modules could not work properly.

Generally, plural solar modules are operated in series connection, wherein a so called bypass diode is anti-parallel connected to each solar module. The bypass diode is disposed inside the junction box and fastened and connected to the electrical connection mechanism of the junction box. In a case of a solar module is shaded or does not produce electricity because of defect, this solar module would lower the power of the solar modules in series connection or even suffers damage without bypass diode. This is because that if a solar cell within a solar cell group of the solar module is partially shaded, this shaded solar cell acts as a blocking diode or resistor within the circuit of the solar cell group, which may result in a damage of the shaded solar cell and result in the entire solar cell group of the solar module no longer being able to supply electric energy. The above-mentioned situations can be avoided by using the bypass diode of the junction box, because the current flows through the diode and is sustained. In other words, the bypass diodes are electrically connected in an anti-parallel manner with respect to the solar cell groups and have the effect that the current flow through the solar module is led past solar cell groups that only supply low power, i.e., the terminals of this solar cell group of a solar module are short-circuited by the bypass diode and the corresponding cell group is bypassed thereby. Thus, such a solar cell group does no longer contribute to the overall performance of the solar module, but the overall current flow through the solar panel is substantially unobstructed and a damage of individual solar cell is avoided.

Thus, through the foregoing descriptions, the bypass diode would avoid a damage of individual solar cell and make the current continuously transmitting; however, the use efficiency of the solar module will decrease as amount of the broken solar cell increases. Users need to get to where the solar module actually is such that the users can know how many the broken solar cells are and then judge whether replace them or not. Besides, the controversial solar module is expensive, complex in construction and installing the junction box is laborious.

It is therefore desirable to provide a junction box that is simple in structure, cost-effective, durable enough to withstand a wide range of environment conditions and easily be installed and maintained, while maintaining a high-quality and users can be informed by an external monitoring and controlling device such that users can judge the timing of repairing and replacing the external solar module and so as to achieve an ultimate using benefit of the external solar module.

### SUMMARY OF THE INVENTION

The primary objective of the present invention is to provide a junction box comprising a housing, an electric connection module, a monitor module, and a cable module. An electric wire of the cable module transmits electricity generated by the external solar module to a power conversion device; moreover, a plurality of signal wires of the cable module transmit the parameter supervised by the monitor module to an external monitoring and controlling device at the same time. Therefore, the monitor module can inform users the broken situation of the solar module such that users can estimate whether the solar module should be repair or exchange and so as to achieve the best using benefit of the solar module.

Accordingly, to achieve the primary objective of the present invention, the inventor of the present invention provides a junction box, comprising:

a housing, having an accommodating space and an wire opening formed on the bottom of the accommodating space, wherein the wire opening is used for guiding a plurality of conductive wires of an external solar module;

an electric connection module, being disposed in the accommodating space and comprising:

a plurality of conductive units, being disposed in the accommodating space wherein one end of each of the conductive units are coupled to the conductive wires for forming at least one electric transmission path; and

a plurality of electric units, being disposed between any two adjacent conductive units for connecting with the conductive units;

a monitor module, being disposed in the accommodating space and coupled to the electric connection module for supervising at least one parameter of the external solar module; and

a cable module, being connected to the housing and coupled to the electric connection module and the monitor module, wherein an electric wire of the cable module transmits electricity generated by the external solar module to a power conversion device; moreover, a plurality of signal wires of the cable module transmit the parameter supervised by the monitor module to an external monitoring and controlling device at the same time.

### BRIEF DESCRIPTION OF THE DRAWINGS

The invention as well as a preferred mode of uses and advantages thereof will be best understood by referring to the following detailed description of an illustrative embodiment in conjunction with the accompanying drawings, wherein:

FIG. 1 is a stereo view of a junction box according to the present invention;

FIG. 2 is a stereo view showing partial components of the junction box;

FIG. 3 is a schematic view of the junction box;

FIG. 4 is a top view showing partial components of the junction box;

FIG. 5 is an exploded diagram of a monitor module of the junction box; and

FIG. 6 is a stereo view of a cable module of the junction box.

### DETAILED DESCRIPTION OF THE PREFERRED EMBODIMENTS

To more clearly describe a junction box according to the present invention, embodiments of the present invention will be described in detail with reference to the attached drawings hereinafter.

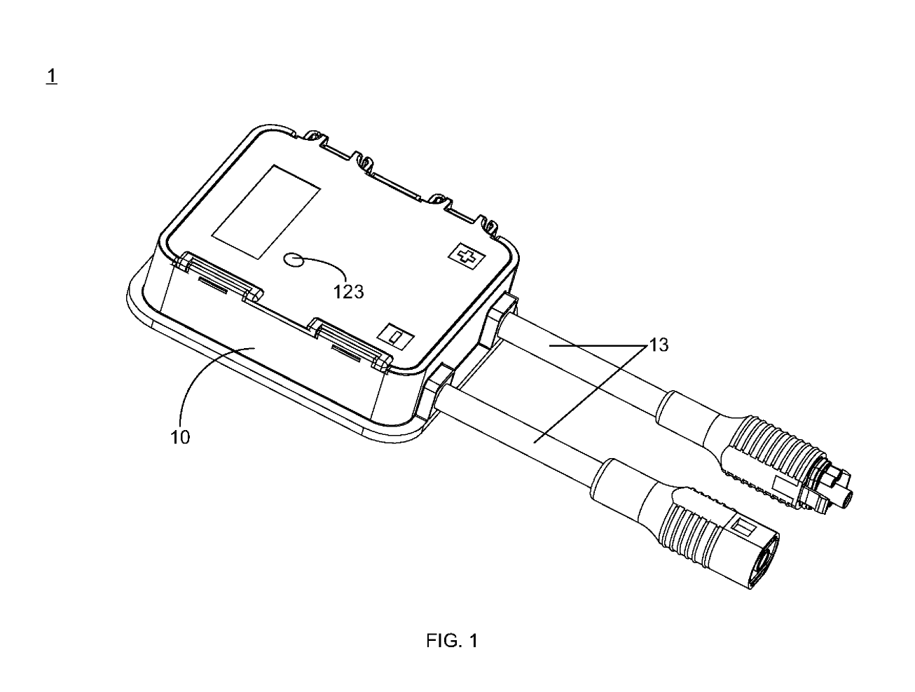

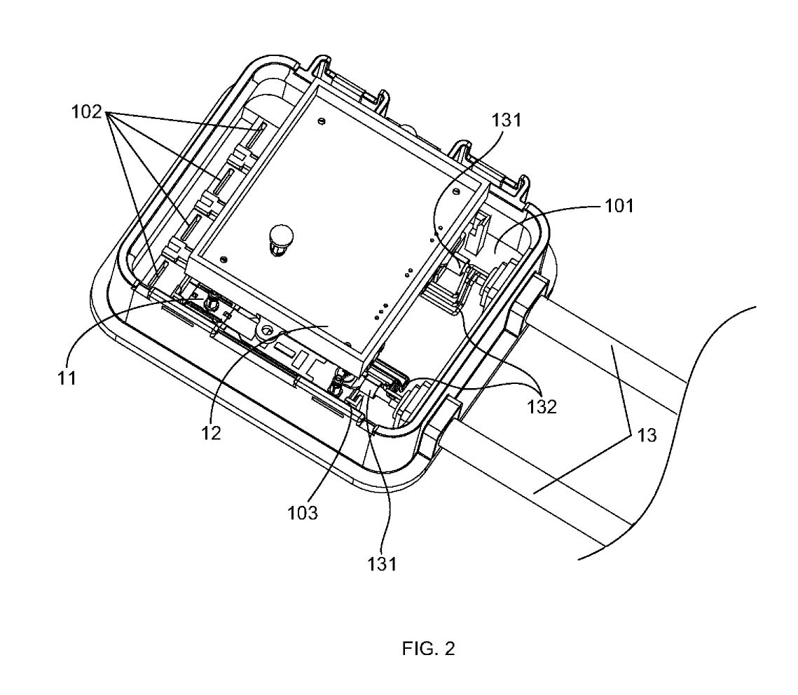

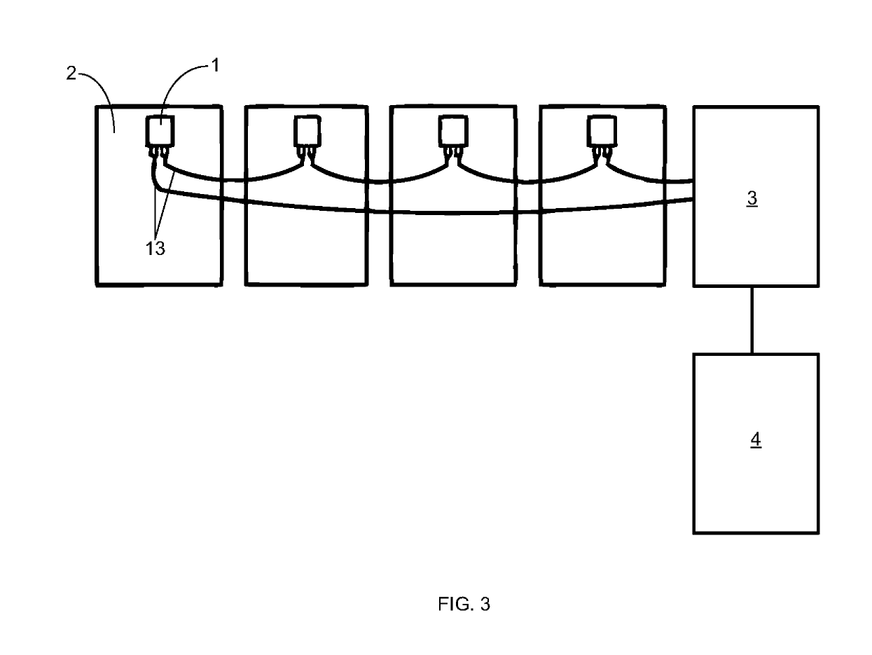

With reference to FIG. 1, which illustrate a stereo view of a junction box according to the present invention. Moreover, please simultaneously refer to FIG. 2, which illustrate a stereo view showing partial components of the junction box. As shown in FIG. 1 and FIG. 2, the junction box 1 of the present invention consists of a housing 10, an electric connection module 11, a monitor module 12, and a cable module 13. Continuously referring to FIG. 1 and FIG. 2, and please simultaneously refer to FIG. 3, which illustrate a schematic view of the junction box. As FIG. 2 and FIG. 3 show, the housing 10 has an accommodating space 101 and an wire opening 102 formed on the bottom of the accommodating space 101, wherein the wire opening 102 is used for guiding a plurality of conductive wires (not shown in FIGS. 2 and 3) of an external solar module 2. Moreover, the electric connection module 11 and the monitor module 12 coupled to the electric connection module 11 for supervising at least one parameter of the external solar module 2 are disposed in the accommodating space 101. The cable module 13 is connected to the housing 10 and coupled to the electric connection module 11 and the monitor module 12, wherein an electric wire 131 of the cable module 13 transmits electricity generated by the external solar module 2 to a power conversion device 3; moreover, a plurality of signal wires 132 of the cable module 13 transmit the parameter supervised by the monitor module 12 to an external monitoring and controlling device 4 at the same time.

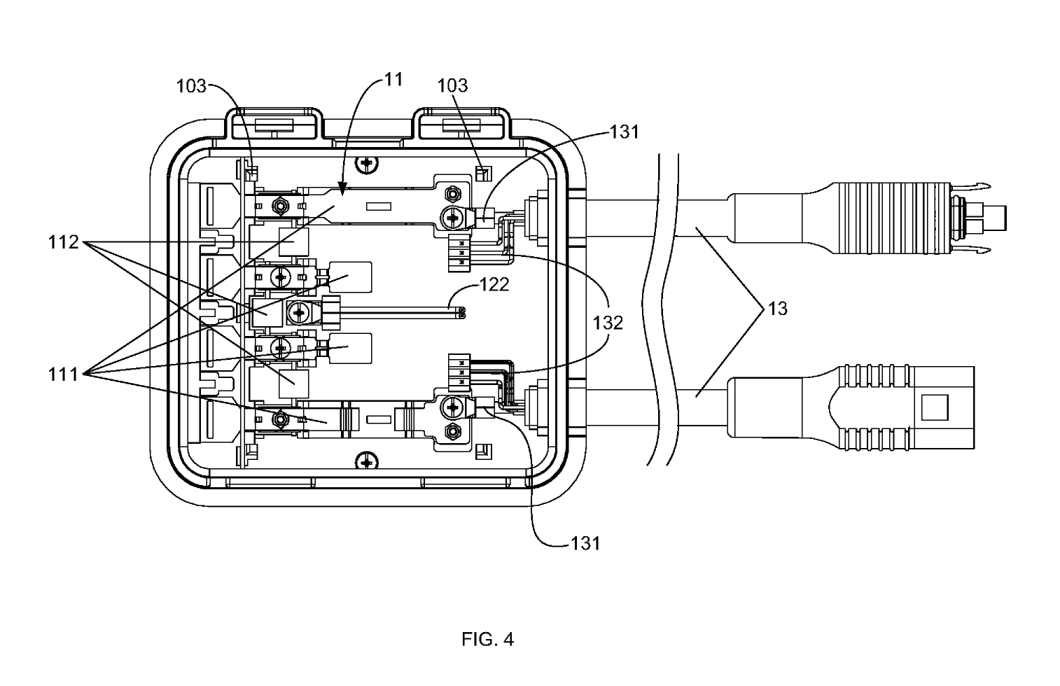

Please refer to FIG. 4, which illustrate a top view showing partial components of the junction box. As FIG. 4 shows, the electric connection module 11 comprises a plurality of conductive units 111 and a plurality of electric units 112 disposed between any two adjacent conductive units 111 for connecting with the conductive units 111, wherein the electric units 112 is a bypass diode. The conductive units 111 are disposed in the accommodating space 101, wherein one end of each of the conductive units 111 are coupled to the conductive wires for forming at least one electric transmission path. In the present invention, the parameter supervised by the monitor module 12 is selected from the group consisting of: voltage data, current data and power data of the external solar module, temperature data of the electric units 112, and combination of two or more aforesaid data.

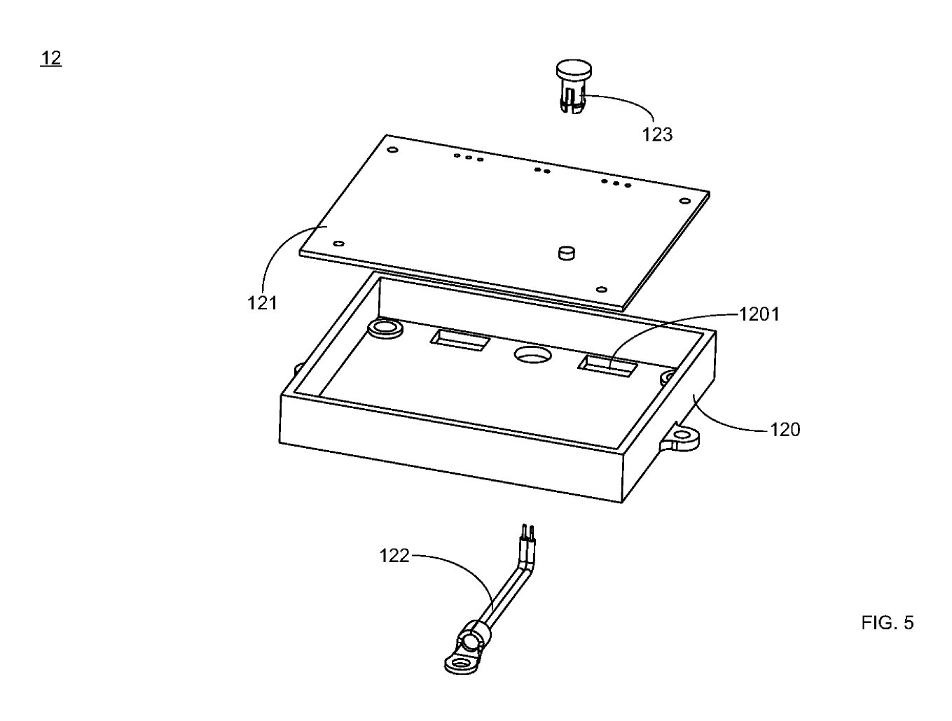

As an exploded diagram of the monitor module shown by FIG. 5, the monitor module 12 comprises a carrier 120, a circuit board 121, a temperature supervising module 122, and a state indicating module 123, wherein the carrier 120 connected with four combining columns 103 formed in the accommodating space 101 has at least one opening 1201. The circuit board 121 is disposed on the carrier 120 and coupled to the electric connection module 11 through the opening 1201. The temperature supervising module 122 is a negative temperature coefficient thermistor, and two ends of the negative temperature coefficient thermistor are coupled to the circuit board 121 through the opening 1201 and disposed in the accommodating space 101 for being adjacent to the electric units 112, therefore, the temperature of the electric units 112 can be detected by the temperature supervising module 122. Moreover, the state indicating module 123 coupled to the circuit board 121 and exposed out of the housing 10 is an LED, wherein the monitor module 12 controls the state indicating module 123 to indicate a specific state information corresponding to the parameter.

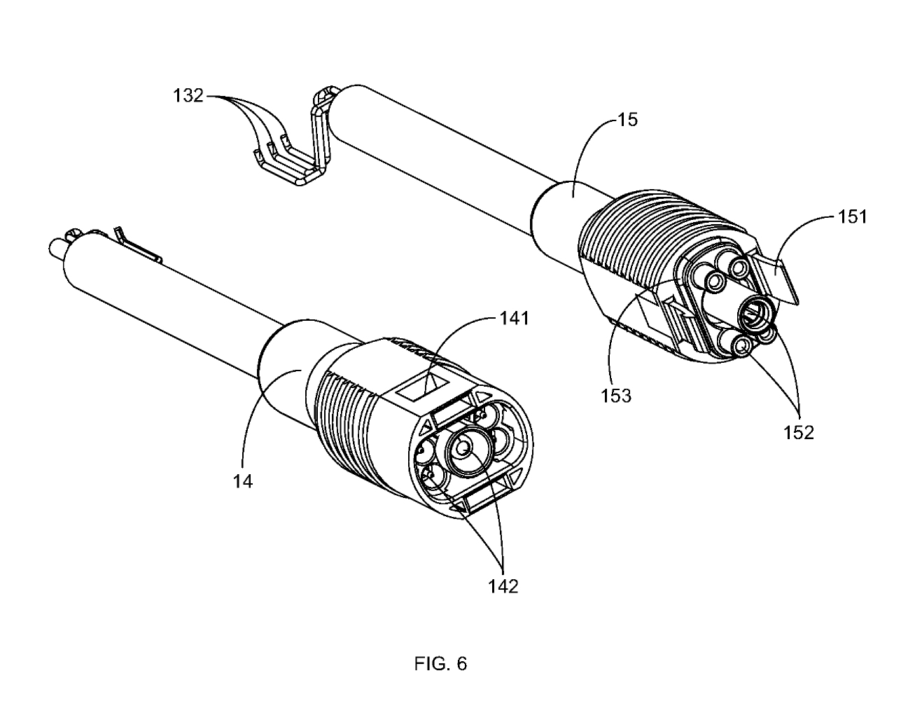

Continuously refers to FIG. 6, which illustrate a stereo view of a cable module of the junction box. As FIG. 6 shows, the cable module 13 is coupled to the electric connection module 11 by the electric wire 131 and the cable module 13 is coupled to the electric connection module 11 by the signal wires 132 passing through the opening 1201. The cable module 13 comprises a female cable 14 and a male cable 15, and the female cable 14 has at least one first buckle element 141 and a plurality of female connectors 142. Opposite to the female cable 14, the male cable 15 has at least one second buckle element 151 and a plurality of male connectors 152, wherein the connection of the male connectors 15 and the female connectors 14 and the connection of the first buckle element 141 and the second buckle element 151 carry out the electric connection between the female cable 14 and the male cable 15. Besides, the electric wire 131 and the signal wires 132 are disposed in the female connectors 142 and the male connectors 152. In the present invention, both of the female connectors 142 and the male connectors 152 have four signal wires.

Inheriting to above descriptions, the male cable 15 further comprises a waterproof ring 153 disposed around the male connectors 152. Moreover, a positive cable connected to a positive end of the junction box 1 is coupled to the conductive units 111 so as to achieve electric connection with the external solar module 2; and a negative cable connected to a negative end of the junction box 1 is coupled to the conductive units 111 by coupling to the monitor module 12 so as to achieve electric connection with the external solar module 2. The external solar module 2 transmits a current from the conductive units 111 to the positive cable and when the current is transmitted from the negative cable back to the monitor module 12, the monitor module 12 connected with the negative cable and the conductive units 111 could supervise the parameter of the external solar module 2. In the present invention, the positive cable is the male cable 15 and the negative cable is the female cable 14.

Thus, through the foregoing descriptions, the junction box has been completely introduced and disclosed; in summary, the present invention has the following advantages:

1. In the present invention, the junction box 1 has a monitor module 12 which can supervise at least one parameter (such as voltage data, current data and power data of the external solar module, temperature data of the electric units 112, and combination of two or more aforesaid data) of the external solar module 2. Moreover, a plurality of signal wires 132 of the cable module 13 transmit the parameter supervised by the monitor module 12 to an external monitoring and controlling device 4 at the same time.

2. Inheriting to above point 1, users would be informed by the external monitoring and controlling device 4 that the using information of the external solar module 2 such that users can judge the timing of repairing and replacing the external solar module 2 and so as to achieve an ultimate using benefit of the external solar module 2.

The above description is made on embodiments of the present invention. However, the embodiments are not intended to limit scope of the present invention, and all equivalent implementations or alterations within the spirit of the present invention still fall within the scope of the present invention.

What is claimed is:

1. A junction box, comprising:
a housing, having an accommodating space and an wire opening formed on the bottom of the accommodating space, wherein the wire opening is used for guiding a plurality of conductive wires of an external solar module;
an electric connection module, being disposed in the accommodating space and comprising:
a plurality of conductive units, being disposed in the accommodating space wherein one end of each of the conductive units are coupled to the conductive wires for forming at least one electric transmission path; and
a plurality of electric units, being disposed between any two adjacent conductive units for connecting with the conductive units;
a monitor module, being disposed in the accommodating space and coupled to the electric connection module for supervising at least one parameter of the external solar module; and
a cable module, being connected to the housing and coupled to the electric connection module and the monitor module, wherein an electric wire of the cable module transmits electricity generated by the external solar module to a power conversion device; moreover, a plurality of signal wires of the cable module transmit the parameter supervised by the monitor module to an external monitoring and controlling device at the same time.

2. The junction box of claim 1, wherein the parameter is selected from the group consisting of: voltage data, current data and power data of the external solar module, temperature data of the electric units, and combination of two or more aforesaid data.

3. The junction box of claim 1, wherein the monitor module comprises:
a carrier, having at least one opening and being connected with four combining columns formed in the accommodating space;
a circuit board, being disposed on the carrier and coupled to the electric connection module through the opening; and
a temperature supervising module, wherein one end of the temperature supervising module couples to the circuit board through the opening and the other end of the temperature supervising module is disposed in the accommodating space and adjacent to the electric units.

4. The junction box of claim 3, wherein the temperature supervising module detects a temperature of the electric units by using at least one negative temperature coefficient thermistor.

5. The junction box of claim 3, wherein the monitor module further comprises a state indicating module coupled to the circuit board and exposed out of the housing;
besides, the monitor module controls the state indicating module to indicate a specific state information corresponding to the parameter.

6. The junction box of claim 5, wherein the state indicating module is a LED.

7. The junction box of claim 1, wherein the cable module is coupled to the electric connection module by the electric wire and the cable module is coupled to the electric connection module by the signal wires passing through the opening.

8. The junction box of claim 7, wherein the cable module comprises:
a female cable having at least one first buckle element and a plurality of female connectors;
a male cable having at least one second buckle element and a plurality of male connectors, wherein the connection of the male connectors and the female connectors and the connection of the first buckle element and the second buckle element carry out the electric connection between the female cable and the male cable.

9. The junction box of claim 8, wherein the electric wire and the signal wires are disposed in the female connectors of the female cable.

10. The junction box of claim 8, wherein the electric wire and the signal wires are disposed in the male connectors of the male cable.

11. The junction box of claim 10, wherein the male cable further comprises a waterproof ring disposed around the male connectors.

12. The junction box of claim 1, wherein a positive cable connected to a positive end of the junction box is coupled to the conductive units so as to achieve electric connection with the external solar module; and a negative cable connected to a negative end of the junction box is coupled to the conductive units by coupling to the monitor module so as to achieve electric connection with the external solar module.

13. The junction box of claim 12, wherein the external solar module transmits a current from the conductive units to the positive cable and when the current is transmitted from the negative cable back to the monitor module, the monitor module connected with the negative cable and the conductive units could supervise the parameter of the external solar module.

14. The junction box of claim 12, wherein the positive cable is the male cable and the negative cable is the female cable.

15. The junction box of claim 1, wherein the electric units is a bypass diode.
